(19) United States
(12) Patent Application Publication
(10) Pub. No.: US 2016/0060024 A1
(43) Pub. Date: Mar. 3, 2016

(54) FILLING SYSTEM AND METHOD USING A SEPARATOR FOR ADHESIVE SOLIDS

(71) Applicant: Nordson Corporation, Westlake, OH (US)

(72) Inventors: Charles P. Ganzer, Cumming, GA (US); Enes Ramosevac, Snellville, GA (US)

(21) Appl. No.: 14/810,578

(22) Filed: Jul. 28, 2015

Related U.S. Application Data
(60) Provisional application No. 62/043,606, filed on Aug. 29, 2014.

(51) Int. Cl. B65D 88/54; B05B 11/00

(52) U.S. Cl. CPC B65D 88/546; B05B 11/3042

(57) ABSTRACT

Apparatus for transferring adhesive solids with a controlled flow. A storage container includes an interior for holding a bulk supply of adhesive solids and further includes a lower interior portion. Outlet structure communicates with the lower interior portion. A separating assembly is positioned proximate to the storage container and engages the bulk supply of adhesive solids proximate the lower interior portion. A drive moves at least a portion of the separating assembly such that the separating assembly engages the bulk supply of adhesive solids and separates adhesive solids from the bulk supply to thereby form the controlled flow of fluidized adhesive solids through the outlet structure.

### CROSS-REFERENCE TO RELATED APPLICATION

This application claims the priority of Application Ser. No. 62/043,606 filed Aug. 29, 2014 (pending), the disclosure of which is hereby incorporated by reference herein.

### TECHNICAL FIELD

The present invention relates generally to hot melt adhesive systems, and more particularly, to fill systems for temporarily storing and transferring unmelted hot melt adhesive solids to pumps that feed melters or dispenser devices.

### BACKGROUND

Hot melt adhesive systems have many applications in manufacturing and packaging. For example, thermoplastic hot melt adhesives are used for carton and case sealing, tray forming, pallet stabilization, nonwoven applications including diaper manufacturing, and many other applications. Hot melt adhesives are typically produced in the form of adhesive “solids,” which include solid or semi-solid pellets and/or particulates. These hot melt adhesive solids are transferred to a melter where the hot melt adhesive solids are melted into a molten liquid form at a desired application temperature. The liquid hot melt adhesive is ultimately dispensed at the application temperature to an object such as a work piece, substrate or product by a dispensing device suitable to the manufacturing or packaging application.

In these hot melt adhesive systems, a supply of unmelted hot melt adhesive solids must be retained and transferred to the melter in order for the melter to continually produce the liquid hot melt adhesive used by the dispensing device. For example, it is known for a person to employ a scoop or bucket to retrieve hot melt adhesive solids from a bulk supply, and to deliver those adhesive solids directly to the melter. This manual process may be undesirable because hot melt adhesive dust may be stirred up during handling and because transferring hot melt adhesive solids in this manner is prone to waste caused by spillage. In addition, manual filling of the melter substantially increases the amount of operator time that must be spent attending to the supply of adhesive solids to the melter.

To address these concerns with manual filling, the adhesive material may be provided on demand by automated filling, depending on the specific design of the melter. In some of these systems, the adhesive solids are designed to be transferred by pressurized air from a pneumatic pump of a fill system into the melter, whenever the melter requires additional material to heat and dispense. In this regard, the fill system ensures that the amount of adhesive material within the melter remains at sufficient levels during operation of the dispensing system. The fill system must be supplied reliably with additional adhesive solids in order to meet the demands of the melter and its associated dispensing device(s) during operation.

One particular type of known fill system is defined by a tote-based pneumatic fill system. The tote-based pneumatic fill system includes a supply container or “tote” with an interior space having a size sufficient to hold enough adhesive solids for multiple hours of operation of the melter(s) connected to the fill system. A transfer pump, such as a pneumatic pump, connects to the tote for moving the adhesive solids via a hose from a lower portion of the tote to the melter. Traditionally, the adhesive solids will gravity feed into the lower portion of the tote toward an inlet of the transfer pump, and this gravity feed leads to a submerging of the pump inlet with adhesive solids.

Pneumatic pumps generally rely on the suction of gas, such as air entrained within gaps between individual pieces of adhesive solids stored within the tote, for moving the adhesive solids at the pump inlet. When the pneumatic pump generates a vacuum at the inlet to draw some of the adhesive solids out of the tote, make-up or replacement gas must typically be drawn through the entire height of adhesive solids stacked within the tote, and this can be difficult. As a result, the transfer pump in conventional tote-based fill systems may become starved for air, which hampers the ability to produce the vacuum required in order to continue moving adhesive solids from the tote.

The adhesive solids may also have a tendency to stick together and form large clumps of adhesive in some environments, further exacerbating the problems with reliably removing the adhesive solids from the tote with the transfer pump. To this end, the clumps of adhesive can become lodged in and block the pump inlet, and the clumps of adhesive also adversely affect the drawing of make-up or replacement gas though the stacked adhesive solids to the pump inlet. This problem with clumping or sticking together is particularly problematic when the adhesive material defines softer formulations, such as rubber-based formulations that tend to be more malleable and sticky under pressure, and also when the tote is used in a relatively warm operating environment. As many of the conventional totes are configured to hold over 150 pounds of adhesive solids for enabling multiple hours of operation, the pump inlets tend to become clogged or starved for air more readily when the tote is completely filled with adhesive (as the weight of adhesive applying pressure to adhesive solids near the pump inlet is greater when the tote is completely filled). However, it is not desirable to only partially fill the tote during each refill cycle because that causes the amount of operator time needed to replenish the supply of adhesive solids in the tote to increase to an undesirable level, perhaps even comparable to operator time for manual filling processes.

Current methods for avoiding clumping or sticking together of adhesive are limited. For example, it is known to apply a mesh or grating to the top opening of the tote in tote-based pneumatic fill systems to prevent clumps of adhesive from being poured into the tote during an operator refill. But such a mesh or grating only removes clumps that occur in bulk supply before the temporary storage within the tote. The clumping or sticking together of adhesive continues over time even after the adhesive solids are placed in the tote, as described above. The mesh or grate provides no solution for this ongoing problem. Therefore, the total storage capacity of totes in these fill systems has been limited or reduced in an attempt to avoid the clumping problem. Moreover, certain types of adhesive formulations (e.g., rubber-based) and adhesive solids defining less free-flowing particulate shapes have been considered unusable with tote-based pneumatic fill systems as a result of these deficiencies. Thus, the conventional tote-based fill systems cannot be used in many applications and continue to struggle with problems caused by clumping of adhesive solids and lack of air flow to the pump inlets.

There is a need, therefore, for improvements in hot melt adhesive systems, and specifically, a need for a storage container and method for use with a transfer pump that addresses present challenges and characteristics such as those discussed above.

### SUMMARY

According to one embodiment of the invention, a fill system for retaining and transferring adhesive solids to an adhesive melter includes a storage container for holding a bulk supply of adhesive solids and a bottom member. The bottom member is spaced from the storage container to define a gap therebetween. The fill system also includes a separator positioned proximate to the storage container and a drive. The separator extends toward the gap and is configured to engage the bulk supply of adhesive solids. The drive is configured to generate relative motion between the separator and the bottom member such that the separator engages the bulk supply of adhesive solids and separates adhesive solids from the bulk supply to thereby form a flow of fluidized adhesive solids through the gap.

With respect to one aspect of the invention, the separator is an elongated arm mounted proximate to the storage container. As such, the elongated arm extends through the gap for engaging the bulk supply of adhesive solids within the storage container.

In another aspect, the invention generally provides apparatus for transferring adhesive solids with a controlled flow. The apparatus includes a storage container for holding a bulk supply of adhesive solids and including a lower interior portion. Outlet structure communicates with the lower interior portion. A separating assembly is positioned proximate to the storage container. The separating assembly is configured to engage the bulk supply of adhesive solids proximate to the lower interior portion. A drive is configured to move at least a portion of the separating assembly such that the separating assembly engages the bulk supply of adhesive solids and separates adhesive solids from the bulk supply to thereby form the controlled flow of fluidized adhesive solids through the outlet structure. As discussed above and herein, the separating assembly may further comprise a bottom plate configured for supporting the bulk supply of adhesive solids within the storage container. Alternatively, the separating assembly may comprise other structure configured to separate adhesive solids from the bulk supply. Moving at least a portion of the separating assembly may involve a rotational drive, or any other suitable type of drive motion designed to separate the adhesive solids from the bulk supply.

With respect to another aspect of the invention, the separator is a conveyor mounted proximate to the storage container. As such, the conveyor extends through the gap for engaging the bulk supply of adhesive solids within the storage container.

In use, a method of retaining and transferring adhesive solids to an adhesive melter includes holding a bulk supply of adhesive solids within a storage container spaced from a bottom member to form a gap. The method also includes generating a relative motion between the bottom member and a separator and engaging the bulk supply of adhesive solids with the separator during the relative motion. Thereby, the separator separates a flow of fluidized adhesive solids from the bulk supply of adhesive solids. Furthermore, the method includes directing the flow of fluidized adhesive solids through the gap between the storage container and the bottom member.

In another aspect, the invention generally provides a method of transferring adhesive solids including holding a bulk supply of adhesive solids within a storage container communicating with an outlet structure. The outlet structure may comprise the gap discussed herein, or any other suitable outlet structure. The method includes generating motion of at least a portion of a separating assembly. The bulk supply of adhesive solids is engaged with the separating assembly while the separating assembly is in motion, thereby separating a flow of fluidized adhesive solids from the bulk supply of adhesive solids. The flow of fluidized adhesive solids is then directed through the outlet structure. Various other aspects of the method will be apparent from the description herein.

These and other objects and advantages of the invention will become more readily apparent during the following detailed description taken in conjunction with the drawings herein.

### BRIEF DESCRIPTION OF THE DRAWINGS

FIG. 1 is a schematic sectional side view of an embodiment of a filling system for adhesive solids according to the invention.

FIG. 2 is an enlarged view of the filling system of FIG. 1, but showing a flow of adhesive stopped through a gap between a storage container and a bottom plate.

FIG. 3 is a schematic sectional top view of the filling system of FIG. 1.

FIG. 4 is a schematic sectional side view of an alternative embodiment of a filling system for adhesive solids according to the invention.

FIG. 5 is a schematic sectional top view of the filling system of FIG. 4.

### DETAILED DESCRIPTION

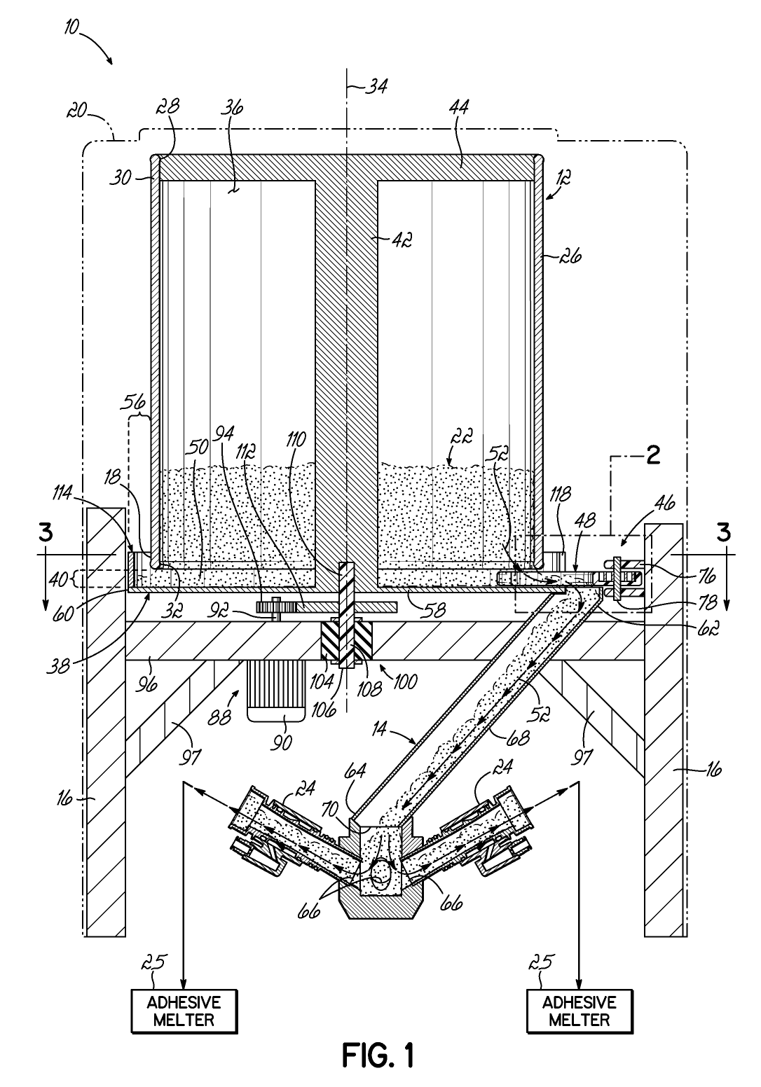

With reference to FIGS. 1 through 3, an exemplary embodiment of a fill system in accordance with the invention is shown in detail. To this end, the fill system includes a storage container that receives a bulk supply of adhesive solids, a separator that is configured to move relative to a surface of the bulk supply to separate adhesive solids from the bulk supply, and a drive that creates the relative motion between the separator and the bulk supply. For example, the separator is configured to scrape through a bottom portion of the bulk supply of adhesive solids as that bulk supply is rotated and fed by gravity through the storage container. Consequently, any solidified masses of adhesive are broken up or blocked from flowing out of the storage container and then into inlets of pumps that may be used to pneumatically deliver the adhesive solids to one or more melters on demand. Accordingly, the fill system improves the reliability and operational performance of adhesive fill systems by reducing the likelihood of problems such as pump inlet flooding, air starvation at the pump, and blockages caused by deformation and coalescing of adhesive solids.

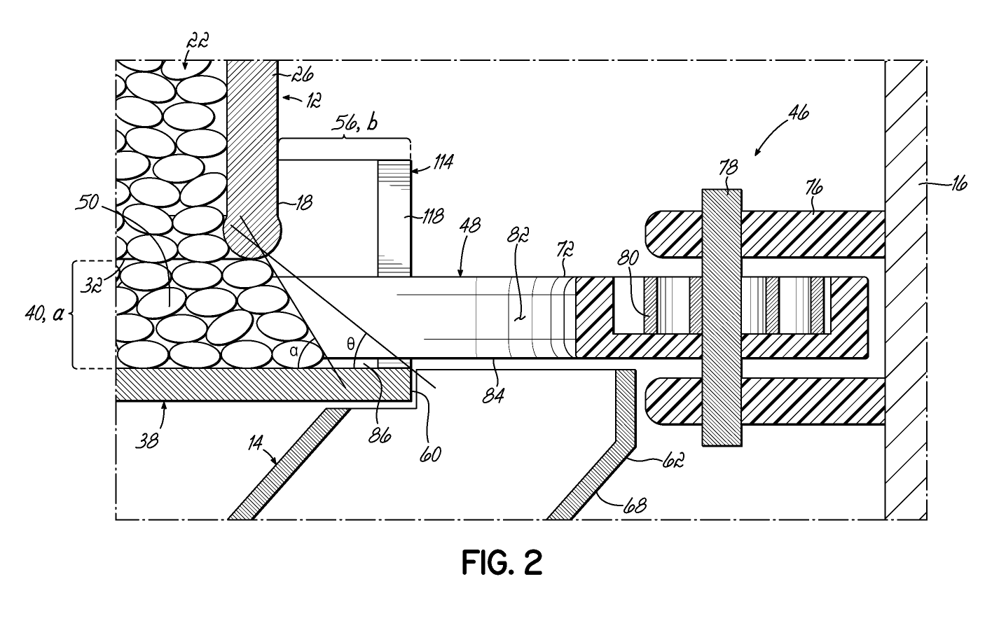

With particular reference to FIGS. 1 and 2, a fill system 10 includes a storage container 12 positioned directly above a pump inlet chamber 14. According to an exemplary embodiment, the pump inlet chamber 14 is a pump inlet chute 14, which will be described below in greater detail. The storage container 12 and the pump inlet chute 14 are each supported by a plurality of support legs 16 operatively coupled to and extending downwardly from a bottom end 18 of the storage container 12. It will be understood that the specific number of support legs 16 and the method of coupling to the bottom end 18 of the storage container 12 may be modified from what is shown in these figures without departing from the scope of the invention. The fill system 10 also includes a housing 20 that covers the storage container 12, the pump inlet chamber 14, the plurality of support legs 16, and other portions of the fill system 10 discussed below for inhibiting an operator from inadvertently contacting one or more moving components of the fill system 10.

The storage container 12 receives and holds a bulk supply 22 of adhesive solids (such as solid adhesive particulate) which may be selectively transferred into the pump inlet chute 14 for delivery to a plurality of pumps 24 communicating with the pump inlet chute 14. Each of the pumps 24 is configured to supply adhesive solids to one or more adhesive melters 25 associated with adhesive dispensing units. Consequently, the storage container 12 is sized to receive a sufficient supply of adhesive to feed the plurality of pumps 24 for a number of hours during normal operation without requiring manual intervention or refill. For example, the storage container 12 in the exemplary embodiment contains up to 150 pounds of adhesive solids when the melters 25 and pumps 24 are configured to receive up to 5 pounds of adhesive per hour in normal operation (collectively up to 20 pounds per hour, or 7-8 hours of operation without intervention). Of course, if demands from the pumps 24 are lessened or fewer pumps 24 are provided, the fill system 10 is capable of supplying adhesive solids for much longer periods of uninterrupted time as well.

The storage container 12 includes a sidewall 26 defining a generally circular cross section from a top opening 28 of a top end 30 to a bottom opening 32 of the bottom end 18. As such, the storage container 12 is hollow, generally cylindrical, and defines a central axis 34. The sidewall 26 defines an interior surface 36 that faces towards the bulk supply 22 of adhesive solids received within the storage container 12. This interior surface 36 may be advantageously formed from or coated with a friction reducing material such as polytetrafluoroethylene or polyethylene. According to the exemplary embodiment, the sidewall 26 extends vertically from the top end 30 to the bottom end 18 such that the top opening 28 is generally the same in cross-sectional size as the bottom opening 32. Consequently, gravitational forces acting on the bulk supply 22 of adhesive solids tend to push those adhesive solids into contact with the sidewall 26 of the storage container 12. Alternatively, the sidewall 26 may taper to reduce the force of the bulk supply 22 acting on the sidewall 26. In any case, the friction reducing material and the angling of the sidewall 26, either alone or in combination, serve to promote downward flow of adhesive solids along the sidewall 26 and towards the bottom opening 32. In this regard, the risk of adhesive solids wedging within the storage container 12 or solidifying along the sidewall 26 is reduced compared to conventional fill system designs.

The fill system 10 further includes a bottom member 38 directly below and spaced from the bottom end 18 of the sidewall 26 to define an outlet or gap 40 therebetween for accessing the bulk supply 22 therein. Therefore, in this illustrative embodiment the bottom member 38 and bottom end 18 comprise outlet structure. In other embodiments, the outlet structure may take other forms. According to an exemplary embodiment, the sidewall 26 is supported above the bottom member 38 via a support member 42 extending upward from the bottom member 38 to a cross-member 44. More particularly, the support member 42 extends upward along the central axis 34 of the storage container 12 with the cross-member 44 being generally transverse to the central axis 34. The cross-member 44 connects to both the interior surface 36 of the storage container 12 and the support member 42 to maintain the gap 40 as a predetermined vertical height discussed below in greater detail. As such, the bottom member 38, the support member 42, the cross-member 44, and the storage container 12 are each rigidly connected. However, it will be appreciated that the storage container 12 may be supported above the bottom member 38 to maintain the gap 40 via any other adjacent structure, such as the support legs 16.

The top opening 28 is shown to be open in FIG. 1. However, it will be appreciated that the top opening 28 could include a lid or a mesh covering in other embodiments of the invention. Such a mesh covering would prevent coalesced clumps of solidified adhesive from being delivered into the storage container 12 when the storage container 12 is refilled at the top opening 28.

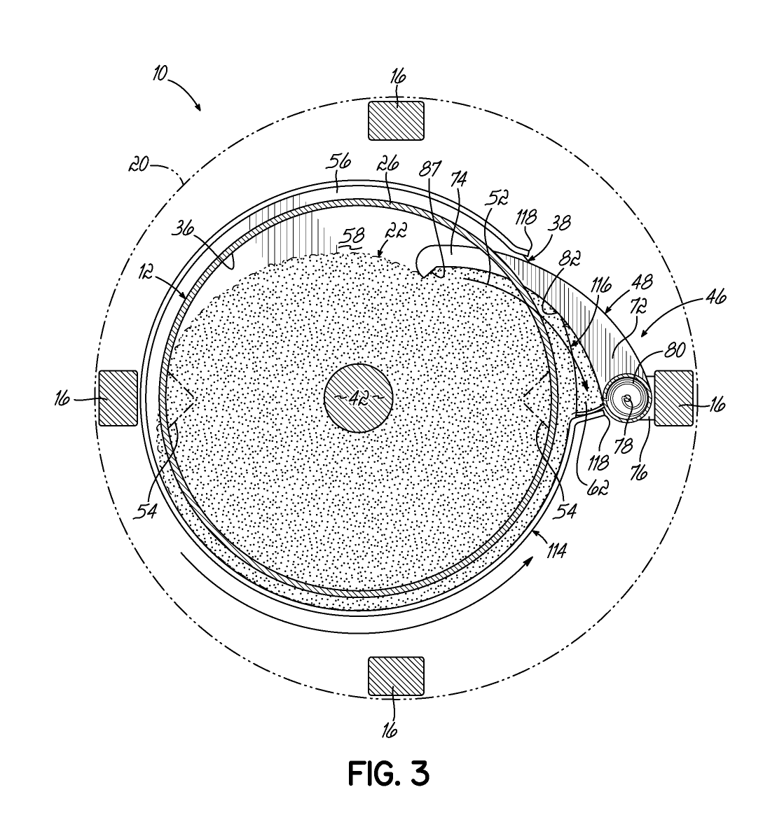

According to the exemplary embodiment of the fill system 10, the bottom member 38 is a bottom plate 38. The bottom plate 38 is located offset and proximate to the bottom end 18 of the storage container 12 to effectively close off or block the bottom end 18 of the storage container 12. As such, the bulk supply 22 of adhesive solids does not uncontrollably feed into the pump inlet chute 14. A separating assembly 46 includes a separator 48 that extends toward and through the gap 40 to engage a bottom portion 50 of the bulk supply 22. As such, the bottom plate 38, in conjunction with the separating assembly 46, functions to control a flow 52 of fluidized adhesive solids between the storage container 12 and the pump inlet chute 14. More specifically, the bottom plate 38 operatively rotates and, in turn, rotates at least the bottom portion 50 of the bulk supply 22 against the separator 48 due to the relative movement between the bottom plate 38 and the separator 48. According to the exemplary embodiment having a rigid connection between the sidewall 26 and the bottom plate 38, the sidewall 26 rotates with the bottom plate 38 to encourage bulk rotation of the bulk supply 22. However, any relative motion between the bottom plate 38 and the separator 48 may be used to generate the flow 52 of fluidized adhesive solids. For example, the separator 48 may alternatively rotate while the bottom plate 38 remains relatively stationary. By way of further example, the separator 48 and the bottom plate 38 may each move so long as relative motion between the bottom plate 38 and the separator 48 forces at least the bottom portion 50 of the bulk supply 22 to scrape against the separator 48 to cause the flow 52 of fluidized adhesive solids through the gap 40. As shown in the exemplary embodiment of FIG. 3, the bottom plate 38 and sidewall 26 rotate counterclockwise when viewed from above. In any case, the separator 48 relative to the bottom plate 38 effectively circumscribes at least a portion of the bottom plate 38 for engaging the bottom portion 50 of the bulk supply 22.

In addition, the sidewall 26 of the storage container 12 may be made non-circular to further encourage bulk rotation of the bulk supply 22 along with the rotation of the bottom plate 38. This optional non-circular shape may be provided by one or more polygonal projections 54 extending into the bulk supply 22 as shown in phantom in FIG. 3. It will be appreciated that other types of structures or modified (non-circular) shapes of the sidewall 26 may be used in other embodiments to achieve these purposes.

With continued reference to FIG. 1, the gap 40 enables selective flow 52 of fluidized adhesive solids out of the storage container 12 and into the pump inlet chute 14 whenever the bottom plate 38 is rotated. However, as described in further detail below, the gap 40 is also sized to restrict the flow 52 of fluidized adhesive solids out of the storage container 12 when the bottom plate 38 stops moving. Accordingly, the bottom plate 38 is larger in size than the bottom end 18 of the storage container 12, which prevents the adhesive solids from continuously flowing around or applying pressure to an outer peripheral end portion 56 defined by the bottom plate 38. In this regard, the bottom plate 38 effectively defines a central plate portion 58 offset from and covering the bottom opening 32 and the outer peripheral end portion 56, which extends radially beyond the central plate portion 58 and beyond the bottom end 18 of the storage container 12 to an outer edge 60 of the bottom plate 38. The bottom plate 38 of this embodiment is configured to rotate at least the bottom portion 50 of the bulk supply 22 of adhesive solids resting on and supported by the bottom plate 38. As a result, the bottom plate 38 of this embodiment is a circular bottom plate 38, although it will be understood that other shapes and cross-sectional configurations of the bottom plate 38 are possible in other embodiments consistent with the scope of the invention.

As briefly described above, the pump inlet chute 14 extends downwardly from an upper chute portion 62 adjacent to and below the separator 48 to a lower chute portion 64 located beneath the bottom plate 38. The lower chute portion 64 communicates with the plurality of pumps 24, which are shown as four pumps 24 in the illustrated embodiment. However, it will be understood that one or more of these pumps 24 could be removed and the corresponding inlets 66 plugged when fewer than four pumps 24 are to be used with the pump inlet chute 14. The pump inlet chute 14 has a generally planar bottom 68 extending between the upper and lower chute portions 62, 64 that slopes directly downward from a portion of the bottom plate 38 adjacent to the separator 48. Thus, the flow 52 of fluidized adhesive solids exiting the storage container 12 through the gap 40 is urged and directed by the separator 48 to the upper chute portion 62. In turn, the flow 52 of fluidized adhesive solids is guided along the planar bottom 68 under the influence of gravity and into the lower chute portion 64 for access by the pumps 24 without significant risk of adhesive build-up or solidification along the walls of the pump inlet chute 14. Alternatively or in addition to the influence of gravity, the flow 52 may be guided under the influence of forced air from a blower device (not shown).

Each of the pumps 24 is mounted to the lower chute portion 64 so that the pumps 24 and the inlets 66 angle upwardly from a bottom end 70 of the lower chute portion 64. The upward angling of the pumps 24 ensures that adhesive solids do not flow or migrate in large quantities into the inlets 66 of pumps 24 that are currently not operating. As a result, blockages caused by adhesive solids coalescing into solidified masses within the inlets 66 are minimized during operation.

According to the exemplary embodiment, the pumps 24 used with this embodiment of the fill system 10 are pneumatic pumps that generate a vacuum or moving air force at the inlets 66 in order to draw and push adhesive solids through the pumps 24 and to the melters 25 or other structures connected downstream of the pumps 24. These pneumatic pumps 24 are largely known in the art and are not described in detail below. In addition, the fill system 10 may include a mechanism for clearing out the adhesive solids in the pump inlet chute 14 between operational cycles of the pumps 24. In one simplified example used with the exemplary embodiment, the pump inlet clearing device includes a vacuum generator (not shown) associated with the pumps 24 and/or a compressed air nozzle in the form of an eductor (not shown) pointed towards the associated inlet 66 of the pumps 24. In any case, the adhesive solids flowing into the lower chute portion 64 are deposited onto the bottom end 70, which is adjacent to the inlets 66 of the pumps 24.

In operation, the bottom plate 38 and sidewall 26 rotate to force the bottom portion 50 of the bulk supply 22 of adhesive solids against the separator 48 extending inward through the gap 40 to separate the flow 52 of fluidized adhesive solids from the bulk supply 22 within the storage container 12. The flow 52 of fluidized adhesive solids moves into the pump inlet chute 14 for removal by the pumps 24. The gap 40 between the bottom plate 38 and sidewall 26 also restricts the flow 52 of fluidized adhesive solids therethrough when the bottom plate 38 is not rotating, so the flow 52 of fluidized adhesive solids is delivered only on demand when needed by the pumps 24. As such, the pump inlet chute 14 is maintained in an empty state between operating cycles of the pumps 24, and stagnation and coalescing of adhesive solids within the pump inlet chute 14 are avoided. The specific operation and functionality of the separating assembly 46, the bottom plate 38, and the associated drive for generating relative motion therebetween are now described in detail below.

With further reference to FIGS. 1 through 3, the separating assembly 46 of this embodiment is designed to separate adhesive solids from the bulk supply 22 of adhesive solids resting on top of the bottom plate 38 within the storage container 12. The separating assembly 46 and the bottom plate 38 accomplish this in two steps. First, the bottom plate 38 produces a relative motion against the generally stationary bulk supply 22 of adhesive solids, which causes the bulk supply 22 of adhesive solids to rotate relative to the separating assembly 46. Second, the rotating bottom portion 50 of the bulk supply 22 engages the separator 48, which separates and breaks up adhesive solids from the bulk supply 22. The separator 48 then urges the separated flow 52 of fluidized adhesive solids to move horizontally outward along the bottom plate 38 before collecting in the pump inlet chute 14 and falling toward the inlets 66 of the pumps 24.

According to the exemplary embodiment of the separating assembly 46, the separator 48 is an elongated arm 48 extending from an inner arm portion 72 to an outer arm portion 74. The inner arm portion 72 is pivotably and resiliently mounted to a fixture bracket 76 having a pin 78 extending therethrough. A spring 80, such as a torsion spring, pivotably biases the elongated arm 48 in a like direction as the operative rotation of the bottom plate 38 such that a guide surface 82 of the elongated arm 48 is biased against the relative movement of the bottom portion 50 of the bulk supply 22 within the storage container 12. The guide surface 82 is generally arcuate and, more particularly, concave and generally transverse to the bottom plate 38 so as to direct the rotating bottom portion 50 of the bulk supply 22 from the central plate portion 58 toward the outer peripheral end portion 56.

A bottom face 84 of the elongated arm 48 is generally planar and supported through the gap 40 via the fixture bracket 76 such that the bottom face 84 is generally parallel with and adjacent to the bottom plate 38. According to the exemplary embodiment shown in FIG. 2, the bottom face 84 slightly offset from the bottom plate 38 to maintain a space 86 therebetween. The space 86 is small enough to inhibit adhesive solids from passing between the elongated arm 48 and the bottom plate 38, but large enough to inhibit the bottom face 84 from contacting the bottom plate 38 during use. Thus, the elongated arm 48 effectively “scrapes” adhesive solids supported via the bottom plate 38 without actually contacting the bottom plate 38. Alternatively, the bottom face 84 may be positioned to contact the bottom plate 38 to similarly scrape the adhesive solids from the bottom plate 38. As described herein, the term “scrape” refers to directing the bottom portion 50 of the bulk supply 22 with the elongated arm 48 positioned adjacent to the bottom plate 38 and may or may not include the elongated arm 48 contacting the bottom plate 38.

The guide surface 82 extends from the inner arm portion 72 to the outer arm portion 74, which also includes an outer guide surface 87 that curves inward to hook generally toward the central axis 34 of the storage container 12. As such, the guide surface 82 separates and collects adhesive solids while the bulk supply 22 rotates and, as the outer guide surface 87 collects more adhesive solids, the increasing collection of adhesive solids is urged by the relative rotation of the bulk supply 22 toward the inner arm portion 72 along the guide surface 82. The elongated arm 48 is biased via the spring 80 to separate and break up the coalesced clumps of adhesive solids, within the storage container 12. The biased mounting with the spring 80 also reduces the force of one or more coalesced clumps of adhesive solids against the elongated arm 48 by recoiling under the influence of the impact and, in turn, improving the useful life of the separating assembly 46.

The bottom plate 38 and sidewall 26 are each operatively rotated by a drive 88, whereas the fixture bracket 76, to which the elongated arm 48 mounts, is mounted stationary to one of the support legs 16. As shown in FIG. 1, the drive 88 includes a motor 90, such as an electric motor, a drive shaft 92, and a drive element 94. The motor 90 is rigidly mounted to one or more support beams 96 braced below the bottom plate 38 with angled members 97, and the drive shaft 92 extends toward the bottom plate 38. The drive element 94, such as a drive gear, is secured to the drive shaft 92. Accordingly, the motor 90 is selectively activated to rotate the drive shaft 92 and the drive element 94 for rotating the bottom plate 38 and the sidewall 26.

According to the exemplary embodiment, the bottom plate 38 and the storage container 12 are rotatably supported by a support framework 100. More particularly, the support framework 100 includes a central bearing member 104 positioned and supported by the support beam 96 extending between the support legs 16. The central bearing member 104 is hollow and therefore receives a support shaft 106 extending downwardly from the central plate portion 58 of the bottom plate 38. The support shaft 106 includes a bottom portion 108 and a top portion 110. The bottom portion 108 of the support shaft 106 is rotatably mounted within the central bearing member 104 and includes a driven portion 112, such as a driven gear, extending toward and operatively engaging the drive element 94 for being rotatably driven. The top portion 110 is rigidly connected to both the bottom plate 38 and the support member 42, which, when rotated, transfers the rotation to the cross-member 44 and the sidewall 26 of the storage container 12.

The support framework 100 therefore enables the bottom plate 38 and storage container 12 to be fully supported and also rotatable. It will be understood that the support framework 100 may be reconfigured in other embodiments of the fill system 10 as long as the support provided enables rotation of the bottom plate 38 and reliable support of the bulk supply 22 of adhesive solids sitting on top of the bottom plate 38.

In any case, the drive 88 enables delivery of the adhesive solids on demand from the pumps 24 and melters 25. The drive 88 may be modified in various ways in other embodiments, such as by including an electric motor to directly rotate the bottom plate 38 and the storage container 12. Regardless of the particular drive 88 used with the fill system 10, the advantageous benefits of supplying adhesive solids to the pumps 24 only when required remain a feature of this fill system 10.

As mentioned above, the flow 52 of fluidized adhesive solids separated from the bulk supply 22 within the storage container 12 selectively flow into the pump inlet chute 14 from around the outer peripheral end portion 56 of the bottom plate 38. To this end, the adhesive solids are scraped from the bulk supply 22 along the outermost edges at the bottom end 18 adjacent to the sidewall 26 within the storage container 12. Furthermore, the separator 48 extends through the gap 40 toward the central axis 34 to engage a central portion of the bulk supply 22 adjacent to the central axis 34 and direct the central portion of the bulk supply 22 along the bottom plate 38 and toward the pump inlet chute 14. As shown in FIGS. 1-3, the scraping process includes urging the flow 52 of fluidized adhesive solids over the outer peripheral end portion 56 of the bottom plate 38 during rotation terminating the flow 52 when the bottom plate 38 stops rotating, respectively.

To this end, the gap 40 along the outer peripheral end portion 56 is sized to restrict the flow 52 of fluidized adhesive solids unless the bottom plate 38 is rotating according to an exemplary embodiment. When the bottom plate 38 rotates, as indicated in FIG. 1 and FIG. 3, the loose adhesive solids at the bottom portion 50 of the bulk supply 22 are forced outwardly by the separator 48 and, to at least some extent, the application of centrifugal force. However, while the storage container 12 and the bulk supply 22 may rotate to generate centrifugal force of the bulk supply 22 against the sidewall 26, rotation is not so fast that a friction force between the bulk supply 22 and the sidewall 26 overcomes the downward force of gravity. As long as the bottom plate 38 rotates, the flow 52 of fluidized adhesive solids is forced over the outer peripheral end portion 56 and falls into the pump inlet chute 14 as shown in FIG. 1 and FIG. 3.

As described briefly above, the gap 40 is sized so as to restrict the flow 52 of fluidized adhesive solids when the bottom plate 38 is not moving. More specifically, the gap 40 is sized relative to the angle of repose defined by the bulk supply 22 adhesive solids being retained within the storage container 12 such that the flow 52 of fluidized adhesive solids is stopped when the bottom plate 38 is not moving. This stopped flow state is shown in FIG. 2, for example. As shown in FIG. 2, the fluidized adhesive solids flow when unrestricted to make a pyramid-shaped pile with sides defined by an angle of repose from the support surface (in this case, the angle of repose is measured from the bottom plate 38). But the gap 40 is dimensioned such that adhesive solids flowing from the bottom end 18 of the storage container 12 and onto the outer peripheral end portion 56 of the bottom plate 38 will not reach the outer edge 60 of the bottom plate 38. Instead, the flow 52 (see FIG. 1) of fluidized adhesive solids will terminate with the bulk supply 22 defining the angle of repose for the bottom portion 50 of adhesive solids adjacent to the bottom end 18. Until the bottom plate 38 is rotated by the drive 88 once again, the bottom portion 50 of adhesive solids will remain in the steady state shown in FIG. 2. It will be understood that a residual amount of the flow 52 of fluidized adhesive solids may continue for a brief period of time following the ceased movement of the bottom plate 38 to allow for the adhesive solids to settle within the storage container 12 to the pyramid-shaped pile static position shown in FIG. 2, but this relatively quick stoppage of the flow 52 is what is considered to be stopping the flow 52 of fluidized adhesive solids when the bottom plate 38 stops rotating.

One example of the relevant angles and distances defined by the gap 40 at the sidewall 26 and the bottom plate 38 is shown in FIG. 2. To this end, the gap 40 is defined by “a” and “b” distances, which correspond to (“a”) the vertical height of the gap 40 and (“b”) the horizontal length of the outer peripheral end portion 56 located beyond the outer circumference of the bottom end 18 of the storage container 12. In the exemplary embodiment, the “a” distance is about 1.5 inches and the “b” distance is about 0.5 inches, which generates a gap angle (θ) of about 20 degrees. By contrast, a typical angle of repose (a) for the adhesive solids is larger, such as 30 to 40 degrees. In view of the smaller angle or larger horizontal distance defined by the gap angle (θ) compared to the angle of repose (a), the adhesive solids pile up and stop flowing at a location short of the outer edge 60. Therefore, the restriction of flow caused by the gap 40 actually terminates the flow 52 of fluidized adhesive solids when the bottom plate 38 is not rotating.

It will be understood that the specific angles and “a” and “b” dimensions provided above are exemplary only and may be modified to suit the needs of the end user of the fill system 10. For example, some adhesive compositions and pellet shapes define different angles of repose, and the gap 40 can be adjusted by modifying the “a” and “b” distances to assure restriction of flow 52 of fluidized adhesive solids between rotation movements of the bottom plate 38.

To further inhibit the flow 52 of fluidized adhesive solids from moving beyond the outer edge 60, a shield 114 is positioned about the outer peripheral end portion 56 of the bottom plate 38 adjacent to the outer edge 60. The shield 114 is rigidly connected to a relatively stationary portion of the fill system 10, such as one or more of the support legs 16, so that the bottom plate 38 may rotate free of the shield 114. More particularly, the shield 114 as seen in FIG. 3 is generally C-shaped and defines a shield opening 116 between each end 118 of the shield 114. The shield opening 116 receives the elongated arm 48 and is sized to accommodate movement of the elongated arm 48 resulting from the biased mounting with the fixture bracket 76. Thereby, the shield 114 blocks the flow 52 of fluidized adhesive solids when the bottom plate 38 is moving except at the shield opening 116 so that both the elongated arm 48 and the shield 114 urge the flow 52 of fluidized adhesive solids into the pump inlet chute 14.

During use of the fill system 10 as shown in FIGS. 1-3, the operator fills the storage container 12 with the bulk supply 22 of a full or otherwise desirable amount of the adhesive solids. In the event that there is no relative movement between the separating assembly 46 and the bottom plate 38, the bottom portion 50 of the bulk supply 22 falls out of the gap 40 with the angle of repose discussed above, and collects at the gap 40 to restrict the flow 52 of any further adhesive solids therethrough. Within the storage container 12, the separator 48 extends through the gap 40 and the bottom portion 50 of the bulk supply 22 piles around the separator 48.

To initiate the flow 52 of fluidized adhesive solids through the gap 40, the motor 90 is powered on manually by the operator or at the signaled request of the melter 25 downstream of the fill system 10. The drive element 94 of the motor 90 engages and rotates the driven portion 112 of the support shaft 106, which, in turn, rotates the bottom plate 38 and the sidewall 26. As the bottom plate 38 rotates, the entire bulk supply 22 of the adhesive solids resting on the bottom plate 38 is similarly forced to rotate relative to the support legs 16 and relative to the separator 48. In other words, the separator 48 effectively circumscribes at least a portion of the bottom plate 38 and the sidewall 26 due to the relative movement therebetween. According to an exemplary embodiment, the bottom plate 38 and the sidewall 26 continuously rotate in full revolutions so that the separator 48 continuously circumscribes the bottom plate 38 and sidewall 26. Once the relative motion ceases, the flow 52 of fluidized adhesive solids also halts.

So long as the flow 52 of fluidized adhesive solids toward the pumps 24 is desirable, the bottom portion 50 of the bulk supply 22 engages the separator 48 and urges the flow 52 of fluidized adhesive solids through the adjacent gap 40 and into the pump inlet chamber 14. In the event that any coalesced clumps of adhesive solids have formed within the bulk supply 22, the clumps will either break up upon impact with the separator 48 to be scraped through the gap 40 as individual pieces or remain within the storage container 12 due to the vertical height of the gap 40. The flow 52 of fluidized adhesive solids is then guided along the pump inlet chamber 14 toward the pumps 24 for being pumped to the melter 25.

More specifically with respect to the separating assembly 46 having the elongated arm 48 urge the flow 52 of fluidized adhesive solids into the pump inlet chute 14, the rotating bottom portion 50 of the bulk supply 22 engages the guide surface 82. The guide surface 82 is biased against the relative movement of the bottom portion 50 and, as such, tends to collect adhesive solids against the hooked outer arm portion 74 and urge the flow 52 of fluidized adhesive solids toward the inner arm portion 72. In doing so, the flow 52 of fluidized adhesive solids passes through the gap 40, over the outer edge 60 of the bottom plate 38, and through the shield opening 116.

The upper chute portion 62 of the pump inlet chute 14 is positioned directly below the portion of the outer edge 60 where the flow 52 of fluidized adhesive solids falls off of the plate for collecting the flow 52 therein. The bottom 68 guides the flow 52 of fluidized adhesive solids directly to the bottom end 70 of the pump inlet chute 14. From the bottom end 70, the flow 52 of fluidized adhesive solids feeds directly into each pump inlet 66 for being pumped to the melter 25. Of course, once the melter 25 receives enough of the adhesive solids, the motor 90 is powered off to cease the relative movement and halt the flow 52 of fluidized adhesive solids through the gap 40 as discussed above.

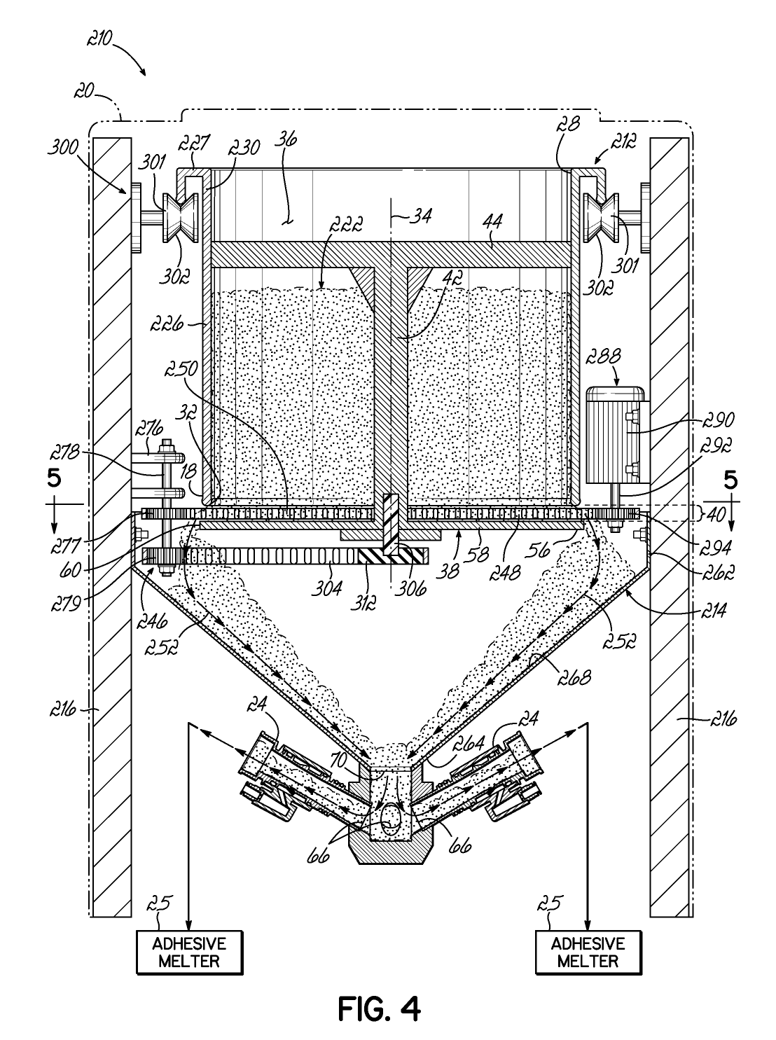

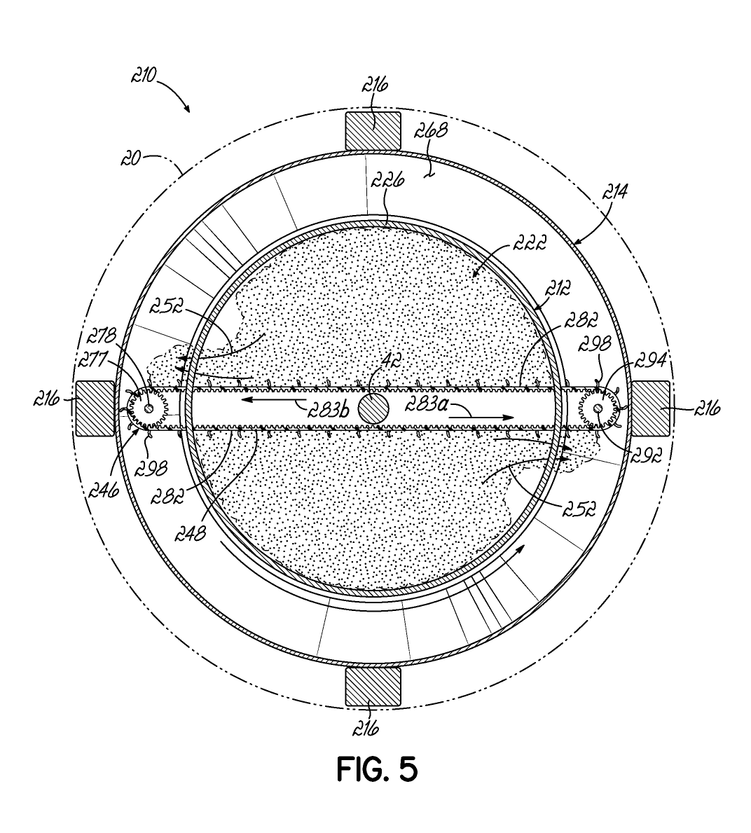

With reference to FIGS. 4-5, an alternative embodiment of a fill system 210 includes a storage container 212 positioned above a pump inlet chamber 214 and a separating assembly 246 for directing a flow 252 of fluidized adhesive solids from a bulk supply 222. At least a portion of the separating assembly 246 extends through the gap 40 between the bottom plate 38 and the bottom end 18 to urge a bottom portion 250 of the bulk supply 220 through the gap 40 similar to the fill system 10 (see FIGS. 1-3). However, the storage container 212 is rotatably hung and rotatably driven via a support framework 300 and a drive 288 as described below in greater detail. As such, like numbers indicate like features already described above.

The storage container 212 includes the sidewall 226 having the bottom end 18 and a top end 230. The top end 230 defines the top opening 28 discussed above and a circumferential lip 227 surrounding the top opening 28. The lip 227 cooperates with the support framework 300 to effectively suspend or hang the storage container 212 within the housing 20. More particularly, the support framework 300 includes a plurality of rollers 301, each of which defines a groove 302 for receiving the lip 227. Each roller 301 is rotatably connected to a support leg 216 such that the lip 227 rests within each groove 302 to circumferentially support the storage container 212 from the top end 230. Thereby, the storage container 212 is free to rotate about its central axis 34 while being suspended above the pump inlet chamber 214.

According to the exemplary embodiment, the pump inlet chamber 214 is a pump inlet funnel 214 supported below the storage container 212 by the plurality of support legs 216. The pump inlet funnel 214 extends downwardly from an upper funnel portion 262 adjacent to and below the entirety of the bottom plate 38 to a lower funnel portion 264 also below the bottom plate 38. The upper funnel portion 262 extends downwardly from the support legs 216 as a converging bottom surface 268 that converges to the lower funnel portion 264 located beneath the upper funnel portion 262. The lower funnel portion 264 communicates with the plurality of pumps 24 as discussed above for delivering the flow 252 of fluidized adhesive solids to one or more melters 25. The upper funnel portion 262 is generally cylindrical and adjacent to the support legs 216 and then becomes funnel-shaped along the converging bottom surface 268 toward the lower funnel portion 264. Thus, the flow 252 of fluidized adhesive solids exiting the storage container 212 are funneled by the upper funnel portion 262 into the lower funnel portion 264 for access by the pumps 24 without significant risk of adhesive build-up or solidification along the converging bottom surface 268 of the pump inlet funnel 214.

The separating assembly 246 includes a separator 248 in the form of an operatively driven conveyor 248. More particularly, the conveyor 248 is a continuous loop chain or belt that extends through the gap 40 for engaging the bottom portion 250 of the bulk supply 222 and urging the flow 252 of fluidized adhesive solids from within the storage container 212 through the gap 40, over the outer edge 60, and into the upper funnel portion 262. In conjunction with the separating assembly 246, the drive 288 includes a motor 290, such as an electric motor, having a drive shaft 292 and a drive element 294, such as a drive gear. The motor 290 is mounted to one of the adjacent support legs 216 so that the drive element 294 vertically aligns with the gap 40. In order to suspend the conveyor 248 through the gap 40, the separating assembly 246 further includes a fixture bracket 276 mounted opposite the drive element 294 on another support leg 216. A driven shaft 278 extending through the fixture bracket 276, and a driven element 277, such as a drive gear, is rotatably mounted on the driven shaft 278. The fixture bracket 276 and driven element 277 are also mounted such that the driven element 277 vertically aligns with the gap 40 and opposite the drive element 294. Finally, the looped conveyor 248 is wrapped about the drive element 294, extended through the gap 40 so as to straddle the central axis 34, and similarly wrapped about the driven element 277.

The looped conveyor 248 defines a pair of opposing guide surfaces 282 urging the bottom portion 250 of the bulk supply 222 from the central plate portion 58 adjacent to the central axis 34 toward the sidewall 226 and through the gap 40. More particularly, during rotation of the looped conveyor 248, each guide surface 282 moves at least linearly across the bottom plate 38 and in a direction opposite the other guide surface 282, as indicated by arrows 283a, 283b. In turn, each guide surface 282 simultaneously directs the flow 252 of fluidized adhesive solids through the gap 40, over the outer edge 60 of the bottom plate 38, and into the pump inlet funnel 214. According to the exemplary embodiment, the guide surfaces 282 also include a plurality of scoops 298 projecting outward therefrom for further engagement with the bottom portion 250 of the bulk supply 222 and increased flow 252 of fluidized adhesive solids.

In conjunction with the relative linear movement of the looped conveyor 248, the drive 288 also generates relative rotation between the looped conveyor 248 and the bottom plate 38. The driven shaft 278 further includes a container drive element 279, such as a drive gear, rigidly affixed thereto that is configured to rotate when the driven element 277 operatively rotates. The container drive element 279 operatively connects to a driven portion 312, such as a driven gear, of a shaft 306 that rigidly connects to the rotatably supported bottom plate 38. The container drive element 279 connects to the driven portion 312 via another continuous loop connector 304, such as a chain or belt. Thus, the motor 90 simultaneously rotates the looped conveyor 248, which, in turn, rotates the bottom plate 38 via the looped connector 304 to generate both relative linear movement of the conveyor 248 and relative rotational movement of the bottom plate 38.

During use of the fill system 210 with the separating assembly 246 having the conveyor 248 urge the flow 252 of fluidized adhesive solids into the pump inlet funnel 214, the rotating bottom portion 250 of the bulk supply 222 engages the opposing guide surfaces 282 of the conveyor 248. In addition, each of the guide surfaces 282 is moving radially outward and opposite from each other relative to the bottom plate 38, as indicated by arrows 283a, 283b. Accordingly, each guide surface 282 tends to collect adhesive solids and urge the flows 252 of fluidized adhesive solids through the gap 40 and over the outer edge 60 of the bottom plate 38. Notably, the flows 252 fall over the outer edge 60 at a position adjacent to each opposing guide surface 282 so that at any time during operation, a pair of flows 252 of fluidized adhesive solids fall over the outer edge 60.

The upper funnel portion 262 of the pump inlet funnel 214 is positioned directly below the entire outer edge 60 so as to collect each flow 252 falling into the pump inlet funnel 214. The converging bottom surface 268 guides the flows 252 of fluidized adhesive solids directly to the bottom end 70 of the pump inlet funnel 214. From the bottom end 70, the flow 252 of fluidized adhesive solids feeds directly into each pump inlet 66 for being pumped to the melters. Of course, once the melter 25 receives enough of the adhesive solids, the motor 290 is powered off to cease the relative movement and halt the flow 252 of fluidized adhesive solids through the gap 40 as discussed above.

The fill systems of the embodiments described above are capable of supplying adhesive solids on demand to pneumatic pumps or other supply mechanisms used with adhesive melters and dispensing units. The fill systems enable adhesives of all types of formulations, including the more malleable adhesives like rubber-based formulations, to be supplied to the melters. As a result of the relative movement or scraping generated by the fill system, even adhesive solids that are known to be non-free flowing can be supplied without significant manual or operator intervention. Furthermore, the fill system may be used in non-favorable system environments such as those with higher ambient temperatures. Thus, the fill systems described herein improve the efficiency and the autonomous nature of current adhesive dispensing systems.

While the present invention has been illustrated by a description of exemplary embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. A fill system for retaining and transferring adhesive solids to an adhesive melter, comprising;
a storage container for holding a bulk supply of adhesive solids;
a bottom member spaced from said storage container to define a gap therebetween;
a separator positioned proximate to said storage container, said separator extending toward said gap and configured to engage the bulk supply of adhesive solids; and
a drive configured to generate relative motion between said separator and said bottom member such that said separator engages the bulk supply of adhesive solids and separates adhesive solids from the bulk supply to thereby form a flow of fluidized adhesive solids through the gap.

2. The fill system of claim 1, wherein said separator is configured to at least partially circumscribe said bottom member for engaging the bulk supply of adhesive solids.

3. The fill system of claim 1, wherein said bottom plate is configured for supporting the bulk supply of adhesive solids within said storage container.

4. The fill system of claim 1, wherein said bottom member is rotatably driven by said drive for rotating the bulk supply of adhesive solids and generating the relative motion between said bottom member and said separator.

5. The fill system of claim 1, wherein said bottom member extends radially beyond said sidewall and said gap is configured to restrict the flow of fluidized adhesive solids at the cessation of relative motion between said separator and said bottom member.

6. The fill system of claim 1 further comprising:
a pump inlet chamber having a first end portion and a second end portion, said first end portion positioned proximate to said separator for collecting the flow of fluidized adhesive solids and guiding the adhesive solids toward said second end portion.

7. The fill system of claim 6, wherein said pump inlet chamber is in the form of a pump inlet chute, and said first end portion of said chute is positioned below only a portion of said gap for collecting the flow of fluidized adhesive solids.

8. The fill system of claim 6, wherein said pump inlet chamber is in the form of a pump inlet funnel having a converging surface, and said first end portion of said converging surface is positioned below an entirety of said gap for collecting the flow of fluidized adhesive solids.

9. The fill system of claim 6 further comprising:
at least one pump communicating with said pump inlet chamber and configured to remove the flow of fluidized adhesive solids from said pump inlet chamber and deliver the flow of fluidized adhesive solids to the adhesive melter.

10. The fill system of claim 1, wherein said storage container includes a sidewall, and the relative motion of said separator to said bottom member is configured to force the flow of fluidized adhesive solids to engage said separator and be directed through said gap from a portion of the bulk supply adjacent to said sidewall.

11. The fill system of claim 1, wherein said storage container includes a central axis extending therethrough, and the relative motion of said separator to said bottom member is configured to force the flow of fluidized adhesive solids to engage said separator and be directed through said gap from a portion of the bulk supply adjacent to said central axis.

12. The fill system of claim 1, wherein said separator is an elongated arm mounted proximate to said storage container such that said elongated arm extends through said gap for engaging the bulk supply of adhesive solids.

13. The fill system of claim 1, wherein said separator is a conveyor mounted proximate to said storage container such that said conveyor extends through said gap for engaging the bulk supply of adhesive solids.

14. The fill system of claim 13, wherein said conveyor is in the form of a continuous loop conveyor operatively driven to generate additional relative motion with said bottom member for increasing the flow of fluidized adhesive solids toward the adhesive melter.

15. The fill system of claim 14, wherein said bottom plate and said continuous loop conveyor are each configured to rotate for increasing the flow of fluidized adhesive solids toward the adhesive melter.

16. Apparatus for transferring adhesive solids with a controlled flow, comprising;
a storage container for holding a bulk supply of adhesive solids and including a lower interior portion;
outlet structure communicating with said lower interior portion;
a separating assembly positioned proximate to said storage container, said separating assembly configured to engage the bulk supply of adhesive solids proximate said lower interior portion; and
a drive configured to move at least a portion of said separating assembly such that said separating assembly engages the bulk supply of adhesive solids and separates adhesive solids from the bulk supply to thereby form the controlled flow of fluidized adhesive solids through said outlet structure.

17. The apparatus of claim 16, wherein said separating assembly further comprises a bottom plate configured for supporting the bulk supply of adhesive solids within said storage container.

18. The apparatus of claim 16, wherein said portion is rotatably driven by said drive.

19. The apparatus of claim 16 further comprising:
a pump inlet chamber having a first end portion and a second end portion, said first end portion positioned proximate to said separating assembly and said outlet structure for collecting the flow of fluidized adhesive solids and guiding the adhesive solids toward said second end portion.

20. The apparatus of claim 19 further comprising:
at least one pump communicating with said pump inlet chamber and configured to remove the flow of fluidized adhesive solids from said pump inlet chamber.

21. A method of retaining and transferring adhesive solids to an adhesive melter, comprising:
holding a bulk supply of adhesive solids within a storage container spaced from a bottom member to form a gap;
generating relative motion between the bottom member and a separator;
engaging the bulk supply of adhesive solids with the separator during the relative motion thereby separating a flow of fluidized adhesive solids from the bulk supply of adhesive solids; and
directing the flow of fluidized adhesive solids through the gap between the storage container and the bottom member.

22. The method of claim 21 further comprising:
ceasing the relative motion between the bottom member and the separator and restricting the flow of fluidized adhesive solids from passing through the gap.

23. The method of claim 21 further comprising:
rotating the bottom member in order to generate the relative motion between the bottom member and the separator.

24. The method of claim 21 further comprising:
collecting the flow of fluidized adhesive solids within a pump inlet chamber and guiding the adhesive solids toward a pump in fluid communication with the pump inlet chamber.

25. The method of claim 24 further comprising:
removing the flow of fluidized adhesive solids from the pump inlet chamber with a pump and delivering the flow of fluidized adhesive solids to the adhesive melter.

26. The method of claim 21 further comprising:
engaging a portion of the bulk supply adjacent to a sidewall of the storage container and forcing the portion of the bulk supply adjacent to the sidewall into the flow of fluidized adhesive solids being directed through the gap via the separator.

27. The method of claim 21 further comprising:
engaging a portion of the bulk supply adjacent to a central axis of the storage container and forcing the portion of the bulk supply adjacent to the central axis into the flow of fluidized adhesive solids being directed through the gap via the separator.

28. The method of claim 27 wherein engaging further comprises:
breaking apart a coalesced clump of adhesive solids into a plurality of pieces of adhesive solids for directing the plurality of pieces of adhesive solids through the gap.

29. A method of transferring adhesive solids, comprising:
holding a bulk supply of adhesive solids within a storage container communicating with an outlet structure;
generating motion of at least a portion of a separating assembly;
engaging the bulk supply of adhesive solids with the separating assembly while the separating assembly is in motion, thereby separating a flow of fluidized adhesive solids from the bulk supply of adhesive solids; and
directing the flow of fluidized adhesive solids through the outlet structure.

30. The method of claim 29 further comprising:
ceasing the motion and restricting the flow of fluidized adhesive solids from passing through the outlet structure.

31. The method of claim 29 further comprising:
collecting the flow of fluidized adhesive solids within a pump inlet chamber and guiding the adhesive solids toward a pump in fluid communication with the pump inlet chamber.

32. The method of claim 31 further comprising:
removing the flow of fluidized adhesive solids from the pump inlet chamber with a pump and delivering the flow of fluidized adhesive solids to another adhesive system component.

33. The method of claim 29 wherein engaging further comprises:
breaking apart a coalesced clump of adhesive solids into a plurality of pieces of adhesive solids for directing the plurality of pieces of adhesive solids through the outlet structure.
